(19) United States
(12) Patent Application Publication
(10) Pub. No.: US 2015/0364040 A1
(43) Pub. Date: Dec. 17, 2015

(54) SYSTEM AND METHOD FOR DETECTING AN EMERGENCY VEHICLE

(71) Applicants: Sascha Simon, Warwick, NY (US); Zvi Huber, Great Falls, VA (US)

(72) Inventors: Sascha Simon, Warwick, NY (US); Zvi Huber, Great Falls, VA (US)

(21) Appl. No.: 14/818,735

(22) Filed: Aug. 5, 2015

Related U.S. Application Data
(63) Continuation-in-part of application No. 14/072,231, filed on Nov. 5, 2013.
Application No. 14/072,231 is a continuation-in-part of application No. 14/095,156, filed on Dec. 3, 2013.
Application No. 14/095,156 is a continuation-in-part of application No. 14/105,744, filed on Dec. 13, 2013, now Pat. No. 8,989,952.
Application No. 14/105,744 is a continuation-in-part of application No. 14/105,934, filed on Dec. 13, 2013.
Application No. 14/105,934 is a continuation-in-part of application No. 14/136,467, filed on Dec. 20, 2013.
Application No. 14/136,467 is a continuation-in-part of application No. 14/664,409, filed on Mar. 20, 2015.
Application No. 14/664,409 is a continuation-in-part of application No. 14/664,424, filed on Mar. 20, 2015.
(60) Provisional application No. 62/033,278, filed on Aug. 5, 2014.
(60) Provisional application No. 62/033,284, filed on Aug. 5, 2014.
(60) Provisional application No. 62/033,290, filed on Aug. 5, 2014.

(51) Int. Cl. G08G 1/01; G08G 1/0967

(52) U.S. Cl. CPC G08G 1/01; G08G 1/096791

(57) ABSTRACT

A device is provided for use at a location. The device includes a processing component, a location mode determining component and a detecting component. The processing component can operate in a location mode when it is at the location and can operate in a second mode. The location mode determining component determines whether the processing component is operating in the location mode and generates a location mode signal when the processing component is operating in the location mode. The detecting component detects an emergency vehicle parameter associated with an emergency vehicle and generates an emergency vicinity signal based on the location mode signal and the detected emergency vehicle parameter.

The present application claims priority from: U.S. Provisional Application No. 61/740,814 filed Dec. 21, 2012; U.S. Provisional Application No. 61/740,831 filed Dec. 21, 2012; U.S. Provisional Application No. 61/740,851 filed Dec. 21, 2012; and U.S. Provisional Application No. 61/745,677 filed Dec. 24, 2012, U.S. Provisional Application No. 61/955,995 filed Mar. 20, 2014, U.S. Provisional Application No. 62/033,278 filed Aug. 5, 2014, U.S. Provisional Application No. 62/033,284 filed Aug. 5, 2014 and U.S. Provisional Application No. 62/033,290 filed Aug. 5, 2014, the entire disclosures of which are incorporated herein by reference. The present application is a continuation-in-part of U.S. application Ser. No. 14/072,231 filed Nov. 5, 2013, is a continuation-in-part of U.S. application Ser. No. 14/095,156 filed Dec. 3, 2013, is a continuation-in-part of U.S. application Ser. No. 14/105,744 filed Dec. 13, 2013, is a continuation-in-part of U.S. application Ser. No. 14/105,934 filed Dec. 13, 2013, is a continuation-in-part of U.S. application Ser. No. 14/136,467 filed Dec. 20, 2013, is a continuation-in-part of U.S. application Ser. No. 14/664,409 filed Mar. 20, 2015 and is a continuation-in-part of U.S. application Ser. No. 14/664,424 filed Mar. 20, 2015, the entire disclosures of which are incorporated herein by reference.

### BACKGROUND

Emergency vehicles, such as ambulances, police and fire vehicles, may negatively affect traffic flow when performing their respective duties. It may be beneficial for drivers to have some early notification of an approaching emergency vehicle, or of a situation having emergency vehicles that will disrupt or slow the traffic flow. With such an early notification, a driver may alter his course to avoid the increased traffic created by the emergency vehicle or the event needing the emergency vehicle.

What is needed is a wireless communication system that acts as an early notification system of an approaching emergency vehicle, or of a situation having emergency vehicles that will disrupt or slow the traffic flow.

### SUMMARY

The present invention provides a wireless communication system and method that acts as an early notification system of an approaching emergency vehicle, or of a situation having emergency vehicles that will disrupt or slow the traffic flow.

Various embodiments described herein are drawn to a device for use at a location. The device includes a processing component, a location mode determining component and a detecting component. The processing component can operate in a location mode when it is at the location and can operate in a second mode. The location mode determining component determines whether the processing component is operating in the location mode and generates a location mode signal when the processing component is operating in the location mode. The detecting component detects an emergency vehicle parameter associated with an emergency vehicle and generates an emergency vicinity signal based on the location mode signal and the detected emergency vehicle parameter.

### BRIEF SUMMARY OF THE DRAWINGS

The accompanying drawings, which are incorporated in and form a pan of the specification, illustrate an exemplary embodiment of the present invention and, together with the description, serve to explain the principles of the invention. In the drawings:

FIG. 1 illustrates an emergency vehicle approaching a vehicle;

FIG. 2 illustrates the emergency vehicle of FIG. 1 approaching the vehicle of FIG. 1, which is being followed by another vehicle:

FIG. 3 illustrates a communication center 302 and the emergency vehicle of FIG. 1 approaching the vehicle of FIG. 1;

FIG. 4 illustrates an example method of detecting and connecting to a short wavelength frequency band wireless network in accordance with aspects of the present invention;

FIG. 5 illustrates an example device in accordance with aspects of the present invention;

FIG. 6 illustrates an example method of registering an emergency vehicle parameter in accordance with aspects of the present invention;

FIG. 7 illustrates an example controlling component of the device of FIG. 5:

FIG. 8 illustrates an example parameter-detecting component of the device of FIG. 5;

FIG. 9 illustrates a method for detecting an emergency vehicle parameter when in a registered vehicle while operating in a registered mode in accordance with aspects of the present invention;

FIG. 10 illustrates an example method of generating a signature associated with an emergency vehicle parameter in accordance with aspects of the present invention; and

FIG. 11 illustrates an example method of verifying an emergency vehicle parameter in accordance with aspects of the present invention.

### DETAILED DESCRIPTION

Aspects of the present invention are drawn to a system and method for communicating with a smartphone to warn a driver that an emergency vehicle is approaching, or of a situation having emergency vehicles that will disrupt or slow the traffic flow.

Aspects of the present invention are drawn to a network of smartphone communicating with one another to warn each other of emergency vehicles. For example, a communication device in one vehicle may detect an emergency vehicle and inform another communication device in a nearby vehicle of the detected emergency vehicle.

Aspects of the present invention are drawn to a smartphone receiving a broadcast from an emergency vehicle to warn the user of the smartphone of the approaching emergency vehicle.

As used herein, the term “smanphone” includes cellular and/or satellite radiotelephone(s) with or without a display (text/graphical); Personal Communications System (PCS) terminal(s) that may combine a radiotelephone with data processing, facsimile and/or data communications capabilities; Personal Digital Assistant(s) (PDA) or other devices that can include a radio frequency transceiver and a pager, Internet/Intranet access, Web browser, organizer, calendar and/or a global positioning system (GPS) receiver; and/or conventional laptop (notebook) and/or palmtop (netbook) computers), tablet(s), or other appliance(s), which include a radio frequency transceiver. As used herein, the term “smartphone” also includes any other radiating user device that may have time-varying or fixed geographic coordinates and/or may be portable, transportable, wearable, installed in a vehicle (aeronautical, maritime, or land-based) and/or situated and/or configured to operate locally and/or in a distributed fashion over one or more location(s).

In accordance with another aspect of the present invention, a smartphone may detect a nearby emergency vehicle. For example a parameter-detecting component may detect parameters associated with an emergency vehicle. Non-limiting examples of such detected parameters in include specific noises or broadcasts. These specific noises and/or broadcasts may have specific signatures. As such, a comparator may compare the signatures associated with the specific noises and/or broadcasts with previously stored signatures in database that are associated with an emergency vehicle. If there is a match, an identifying component may identify the emergency and provide an indication to the user. Non-limiting examples of indications include audio, visual, tactile and combinations thereof.

Aspects of the present invention are drawn to a network of smartphone communicating with one another to warn each other of emergency vehicles. For example, once the smartphone detects an emergency vehicle, the smartphone may inform another smartphone in a nearby vehicle of the detected emergency vehicle.

Other aspects of the present invention are drawn to a smartphone receiving a broadcast from an emergency vehicle to warn the user of the smartphone of the approaching emergency vehicle. For example, an emergency vehicle may broadcast an identifying signal that may be received and recognized by the smartphone. Again, once the emergency vehicle is identified, the smartphone may warn the user of the emergency vehicle and/or may inform other nearby smartphones.

Still other aspects of the present invention are drawn to a smartphone receiving a broadcast from a communication center to warn the user of the smartphone of the location of an emergency vehicle. For example, an emergency dispatch center may broadcast an identifying signal that may be received and recognized by the smartphone. Again, once the emergency vehicle is identified, the smartphone may warn the user of the emergency vehicle and/or may inform other nearby smartphones.

In one non-limiting example embodiment, a communication device, e.g., a smartphone: 1) automatically determines wither it is in a registered location; 2) automatically determines whether it is operating in a registered location mode; 2) automatically detects an emergency vehicle based on an emergency vehicle parameter; and 3) automatically performs a function in response to the emergency vehicle detection.

A communication device in accordance with aspects of the present invention will enable a driver to avoid slow areas of traffic by avoiding emergency vehicles.

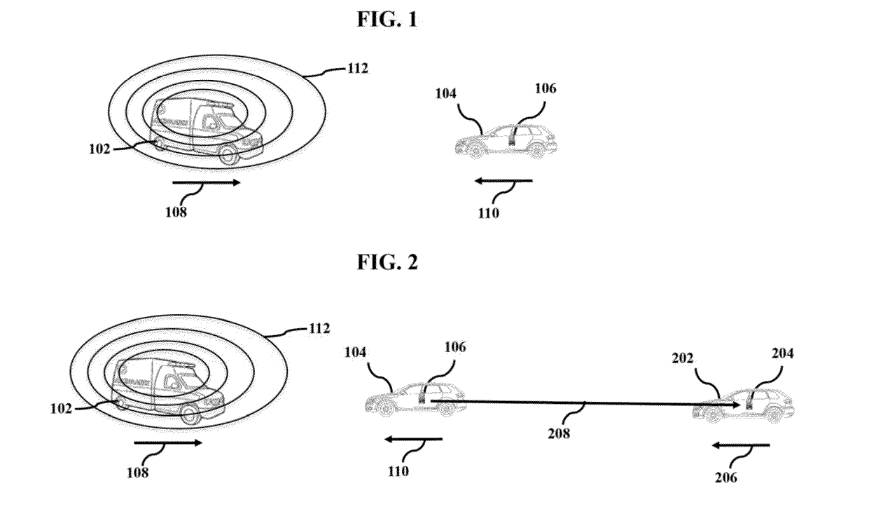

Aspects of the present invention will now be described with reference to FIGS. 1-11.

FIG. 1 illustrates an emergency vehicle 102 approaching a vehicle 104.

As shown in the figure, vehicle 104 has a communication device 106 therein. Emergency vehicle 102 is traveling in a direction 108 towards vehicle 104, whereas vehicle 104 is traveling in a direction 110 toward emergency vehicle 102. Further, emergency vehicle 102 is emitting a warning signal 112.

Warning signal 112 may be any signal comprised of detectable parameters associated with emergency vehicle 102, non-limiting examples of which include sound, light, a change in sound, a change in light and an actual signal transmitted from emergency vehicle 102.

In the situation of FIG. 1, communication device 106 may detect emergency vehicle 102 via warning signal 112. After detecting emergency vehicle 102, communication device 106 may provide a warning to the driver of vehicle 102 that emergency vehicle 102 is approaching. In some cases, the driver of vehicle 102 may the take action to avoid emergency vehicle 102, e.g., take a different route so as to avoid any traffic created by emergency vehicle 102.

In some cases situations, the ability of communication device 106 to detect emergency vehicle 102 may be spatially limited. For example, its ability to detect a parameter of emergency vehicle 102 may be limited to a specific distance from emergency vehicle 102. As such, in some embodiments, communication device 106 may “chain” the detection of emergency vehicle 102. This will be described in greater detail with reference to FIG. 2.

FIG. 2 illustrates emergency vehicle 102 approaching vehicle 104, which is being followed by a vehicle 202.

The situation of FIG. 2 is similar to that as shown in FIG. 1, whereas FIG. 2 additionally includes vehicle 202, which has a communication device 204 therein. Further, vehicle 202 is traveling in a direction 206 toward vehicle 104. Still further, communication device 106 is emitting a warning signal 208.

Warning signal 208 may be any signal that communicates the information of emergency vehicle 102 to communication device 204. In an example embodiment, warning signal 208 includes position and velocity information of communication device 106. In some embodiments, communication device 204 may use the position and velocity information of communication device 106 within signal 208 in combination with position and velocity information of communication device 204 to estimate a distance to emergency vehicle 102.

In the situation of FIG. 2, communication device 106 may detect emergency vehicle 102 via warning signal 112 and then transmit an emergency vehicle signal 208 to communication device 204. Emergency vehicle signal 208 may inform communication device 204 of emergency vehicle 102 even though vehicle 202 is out of range for communication device 204 to detect emergency vehicle 102 via warning signal 112.

In this manner, the detection of emergency vehicle 102 is chained from communication device 106 to communication device 204. After detecting emergency vehicle 102, communication device 204 may provide a warning to the driver of vehicle 202 that emergency vehicle 102 is approaching. In some cases, the driver of vehicle 202 may the take action to avoid emergency vehicle 102.

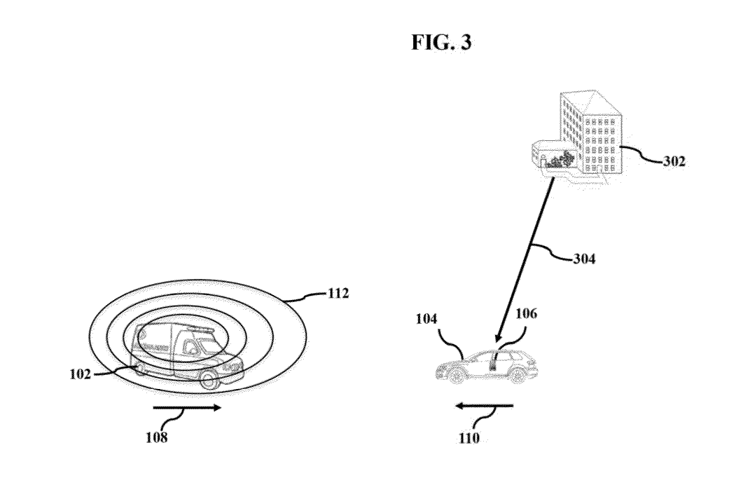

In yet other embodiments, a third party may provide a warning signal associated with an emergency vehicle to a communication device. This will be described with reference to FIG. 3.

FIG. 3 illustrates a communication center 302 and emergency vehicle 102 approaching vehicle 104.

The situation of FIG. 3 is similar to that as shown in FIG. 1, whereas FIG. 3 additionally includes communication center 302, which is emitting a warning signal 304.

The situation of FIG. 3 is similar to that as shown in FIG. 1, whereas FIG. 3 communication center 302 is emitting a warning signal 304.

Warning signal 304 may be any signal that communicates the information of emergency vehicle 102 to communication device 106. In an example embodiment, warning signal 304 includes position and velocity information of vehicle 102. In some embodiments, communication device 106 may use the position and velocity information of emergency vehicle 102 within signal 304 in combination with position and velocity information of communication device 106 to estimate a distance to emergency vehicle 102.

In the situation of FIG. 3, communication center 302 manage/dispatch emergency vehicle 102. Further, communication center may monitor the position and route of emergency vehicle 102. This position/route information may be transmitted to devices within a transmission area. In this example, communication device 106 is located within the transmission area so as to receive warning signal 304. Warning signal 304 includes information of emergency vehicle 102 that is sufficient for communication device 106 to detect emergency vehicle 102 without warning signal 112.

After detecting emergency vehicle 102, communication device 104 may provide a warning to the driver of vehicle 104 that emergency vehicle 102 is approaching. Again, in some cases, the driver of vehicle 104 may the take action to avoid emergency vehicle 102.

Still further, in some embodiments a third party may provide a warning signal, as discussed above with reference to FIG. 3, and a communication device may chain the detection to another communication device in a manner discussed above with reference to FIG. 2. In this manner, the detection of emergency vehicle 102 may be first performed from the warning signal of the third party and then chained to another communication device.

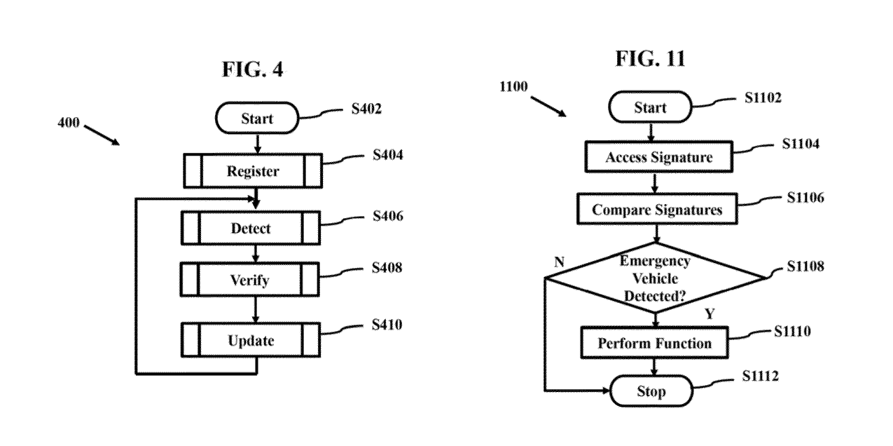

Example methods of detecting a predetermined location and then actively detecting emergency vehicle parameters in accordance with aspects of the present invention will now be described with additional reference to FIGS. 4-11.

FIG. 4 illustrates an example method 400 of detecting an emergency vehicle parameter via a communication device in accordance with aspects of the present invention.

Method 400 starts (S402) and a location, a location mode and an emergency vehicle parameter are registered (S404).

As for registration of a location, any known method may be used, a non-limiting example of which is disclosed in for example, U.S. utility patent application Ser. No. 14/092,231 filed Nov. 5, 2013.

As for registration of a location mode, any known method may be used, a non-limiting example of which is disclosed in for example, U.S. utility patent application Ser. No. 14/095,156 filed Dec. 3, 2013.

As for registration of an emergency vehicle parameter, for example, a user may register any detectable parameter associated with an emergency vehicle, non-limiting examples of which include sound, lights, change in sound, change in lights, a signal transmitted from the emergency vehicle and combinations thereof.

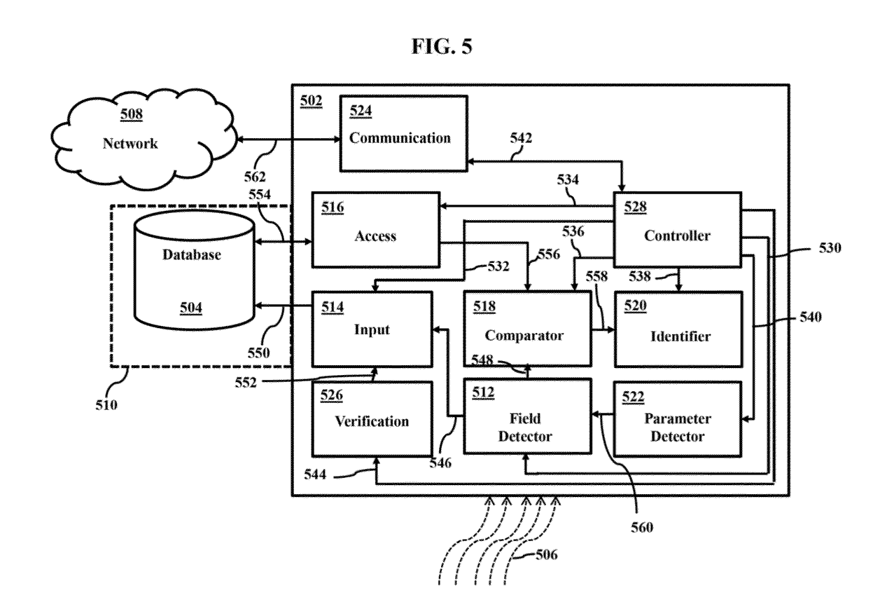

A more detailed discussion of registration of a location, a location mode and an emergency vehicle parameter will now be provided with additional reference to FIGS. 5-11.

FIG. 5 illustrates an example device 502 in accordance with aspects of the present invention.

FIG. 5 includes a device 502, a database 504, a field 506 and a network 508. In this example embodiment, device 502 and database 504 are distinct elements. However, in some embodiments, device 502 and database 504 may be a unitary device as indicated by dotted line 510.

Device 502 includes a field-detecting component 512, an input component 514, an accessing component 516, a comparing component 518, an identifying component 520, a parameter-detecting component 522, a communication component 524, a verification component 526 and a controlling component 528.

In this example, field-detecting component 512, input component 514, accessing component 516, comparing component 518, identifying component 520, parameter-detecting component 522, communication component 524, verification component 526 and controlling component 528 are illustrated as individual devices. However, in some embodiments, at least two of field-detecting component 512, input component 514, accessing component 516, comparing component 518, identifying component 520, parameter-detecting component 522, communication component 524, verification component 526 and controlling component 528 may be combined as a unitary device. Further, in some embodiments, at least one of field-detecting component 512, input component 514, accessing component 516, comparing component 518, identifying component 520, parameter-detecting component 522, communication component 524, verification component 526 and controlling component 528 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM. EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Controlling component 528 is arranged to communicate with: field-detecting component 512 via a communication line 530; input component 514 via a communication line 532; accessing component 516 via a communication line 534; comparing component 518 via a communication line 536; identifying component 520 via a communication line 538; parameter-detecting component 522 via a communication line 540; communication component 524 via a communication line 542; and verification component 526 via a communication line 544. Controlling component 528 is operable to control each of field-detecting component 512, input component 514, accessing component 516, comparing component 518, identifying component 520, parameter-detecting component 522, communication component 524 and verification component 526.

Field-detecting component 512 is additionally arranged to detect field 506, to communicate with input component 514 via a communication line 546, to communicate with comparing component 518 via a communication line 548 and to communicate with parameter-detecting component 522 via a communication line 645. Field-detecting component 512 may be any known device or system that is operable to detect a field, non-limiting examples of which include an electric field, a magnetic field, and electro-magnetic field and combinations thereof. In some non-limiting example embodiments, field-detecting component 512 may detect the amplitude of a field at an instant of time. In some non-limiting example embodiments, field-detecting component 512 may detect a field vector at an instant of time. In some non-limiting example embodiments, field-detecting component 512 may detect the amplitude of a field as a function over a period of time. In some non-limiting example embodiments, field-detecting component 512 may detect a field vector as a function over a period of time. In some non-limiting example embodiments, field-detecting component 512 may detect a change in the amplitude of a field as a function over a period of time. In some non-limiting example embodiments, field-detecting component 512 may detect a change in a field vector as a function over a period of time. Field-detecting component 512 may output a signal based on the detected field.

Input component 514 is additionally arranged to communicate with database 504 via a communication line 550 and to communicate with verification component 526 via a communication line 552. Input component 514 may be any known device or system that is operable to input data into database 504. Non-limiting examples of input component 514 include a graphic user interface (GUI) having a user interactive touch screen or keypad.

Accessing component 516 is additionally arranged to communicate with database 504 via a communication line 554 and to communicate with comparing component 518 via a communication line 556. Accessing component 516 may be any known device or system that access data from database 504.

Comparing component 518 is additionally arranged to communicate with identifying component 520 via a communication line 558. Comparing component 518 may be any known device or system that is operable to compare two inputs.

Parameter-detecting component 522 is additionally arranged to communicate with identifying component 522 via a communication line 290. Parameter-detecting component 522 may be any known device or system that is operable to detect a parameter, non-limiting examples of which include velocity, acceleration, angular velocity, angular acceleration, geodetic position, light, sound, temperature, vibrations, pressure, biometrics, contents of surrounding atmosphere, a change in geodetic position, a change in light, a change in sound, a change in temperature, a change in vibrations, a change in pressure, a change in biometrics, a change in contents of surrounding atmosphere and combinations thereof. In some non-limiting example embodiments, parameter-detecting component 522 may detect the amplitude of a parameter at an instant of time. In some non-limiting example embodiments, parameter-detecting component 522 may detect a parameter vector at an instant of time. In some non-limiting example embodiments, parameter-detecting component 522 may detect the amplitude of a parameter as a function over a period of time. In some non-limiting example embodiments, parameter-detecting component 522 may detect a parameter vector as a function over a period of time. In some non-limiting example embodiments, parameter-detecting component 522 may detect a change in the amplitude of a parameter as a function over a period of time. In some non-limiting example embodiments, parameter-detecting component 522 may detect a change in a parameter vector as a function over a period of time.

Communication component 524 is additionally arranged to communicate with network 508 via a communication line 562. Communication component 524 may be any known device or system that is operable to communicate with network 508. Non-limiting examples of communication component include a wired and a wireless transmitter/receiver.

Verification component 526 may be any known device or system that is operable to provide a request for verification. Non-limiting examples of verification component 526 include a graphic user interface having a user interactive touch screen or keypad.

Communication lines 530, 532, 534, 536, 538, 540, 542, 544, 645, 546, 548, 550, 552, 554, 556, 558, 290 and 562 may be any known wired or wireless communication line.

Database 504 may be any known device or system that is operable to receive, store, organize and provide (upon a request) data, wherein the “database” refers to the data itself and supporting data structures. Non-limiting examples of database 504 include a memory hard-drive and a semiconductor memory.

Network 508 may be any known linkage of two or more communication devices. Non-limiting examples of database 508 include a wide-area network, a local-area network and the Internet.

For purposes of discussion, consider the example discussed above with reference to FIG. 1, wherein a person is driving vehicle 104 and is carrying device 106, which is in a location mode.

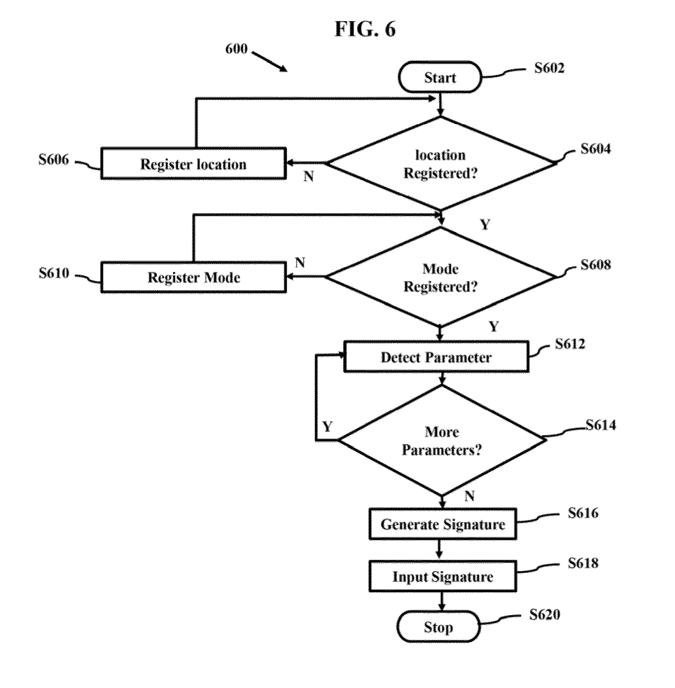

FIG. 6 illustrates an example method 600 of registering an emergency vehicle parameter in accordance with aspects of the present invention.

As shown in the figure, method 600 starts (S602) and it is determined whether the current location is registered (S604). In this example, the location is a vehicle. For example, detected parameters of the current vehicle may be used to generate a vehicle signature associated with the current vehicle. This type of vehicle signature generation may be performed by any known method, a non-limiting example of which is disclosed in U.S. patent application Ser. No. 14/092,231. As shown in FIG. 5, the vehicle signature for the current vehicle may be stored in database 504. Databased 504 may have a plurality of vehicle signatures for a plurality of vehicles, each of which may have been supplied to database 504 as a priori information.

Returning to FIG. 6, if it is determined that the current location is not registered (N at 5604), then the location is registered (S606). For example, returning to FIG. 5, controlling component 528 may register the current vehicle.

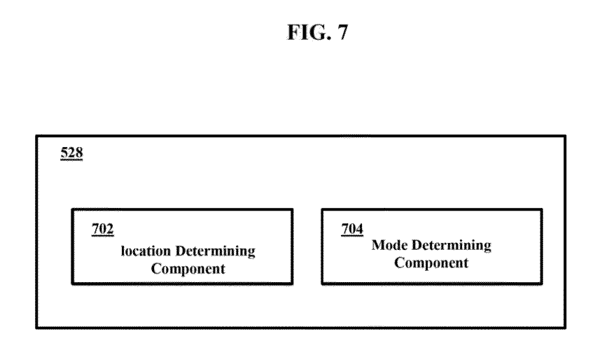

FIG. 7 illustrates an example controlling component 528.

As shown in the figure, controlling component 528 includes a location determining component 702 and a mode determining component 704.

In this example, location determining component 702 and mode determining component 704 are illustrated as individual devices. However, in some embodiments, location determining component 702 and mode determining component 704 may be combined as a unitary device. Further, in some embodiments, at least one of location determining component 702 and mode determining component 704 may be implemented as a computer having tangible computer-readable media for carrying or having computer-executable instructions or data structures stored thereon.

Location determining component 702 may be any device or system that is able to determine whether device 502 is in a predetermined location. Mode determining component 704 may be any device or system that is able to determine whether device 502 is in a location mode and generate a location mode signal when device 502 is operating in the location mode.

One non-limiting example of location determining component 702 being able to register the current location includes the situation when a user instructs device 502 to register the current vehicle by way of input component 514. For example, a user may activate an icon on the GUI to indicate that device 502 is now in a vehicle. Such activation of the GUI would inform location determining component 702 that device 502 is in a predetermined vehicle.

Another non-limiting example of location determining component 702 being able to register the current vehicle includes detecting a field by way of field-detecting component 512. For example, returning to FIG. 5, field-detecting component 512 detects field 506. For purposes of discussion, let field 506 be a magnetic field corresponding to the superposition of magnetic fields generated by all electronic and mechanical systems involved with the running vehicle. A detected field signature may be compared with a priori field signature by any known manner, a non-limiting example of which includes that as described in U.S. patent application Ser. No. 14/092,231.

Another non-limiting example of location determining component 702 being able to register the current vehicle includes detecting other parameters by way of parameter-detecting component 522. These other detected parameters may be used to generate a vehicle signature, which in turn will be compared with a priori vehicle signatures by any known manner, a non-limiting example of which includes that as described in U.S. patent application Ser. No. 14/092,231.

In some embodiments, device 502 has a predetermined number of parameters to detect, wherein controlling component 528 may control such detections. For example, the first parameter to be detected may be a magnetic field associated with a running vehicle, wherein controlling component 528 may instruct field-detecting component 512 to detect a magnetic field. Further, a second parameter to be detected may be another known detected parameter additionally associated with the running vehicle. e.g., vibrations in the chassis, wherein controlling component 528 may instruct parameter-detecting component 522 to detect the second parameter. Further parameter-detecting component 522 may be able to detect many parameters.

For example, detected parameters of the current vehicle may be used to generate a vehicle signature associated with the current vehicle. This type of vehicle signature generation may be performed by any known method, a non-limiting example of which is disclosed in U.S. patent application Ser. No. 14/092,231, wherein location determining component 702 may control field-detecting component 512, parameter-detecting component 522, comparing component 518 and input component 514 to generate and store a vehicle signature of the current vehicle into database 504.

At this point, in this example, the vehicle of the user of device 502 is registered. As such, device 502 will now automatically recognize when it is in the vehicle of the user of device 502.

Returning to FIG. 6, now that the current vehicle is registered (S606 then returns to S604), it is determined whether the location mode is registered (S608). For example, returning to FIG. 5, controlling component 528 may determine whether the location mode is registered. In some embodiments, device 502 may have specific preset modes, such as a vehicle mode, a sleep mode, a low power mode, a specific location mode, etc., wherein each mode is associated with a respective location.

Returning to FIG. 6, if it is determined that the location mode is not registered (N at S608), then the mode is registered (S610). For example, returning to FIG. 5, controlling component 528 may register the location mode. In some embodiments, device 502 may enable a user to establish modes, such as a vehicle mode, a sleep mode, a low power mode, a specific location mode, etc. In an example embodiment, the user may use the GUI to establish a mode by assigning a location mode to the current location.

In this manner, in some embodiments, controller may instruct input component 514 to input the relationships between registered vehicles and registered modes into database 504. These relationships may be stored in any known method, a non-limiting example of which includes a lookup table. When the determined vehicle corresponds to a previously registered vehicle, and the determined vehicle coincides with the determined vehicle mode, which corresponds to a previously registered location mode, then device 502 may automatically detect an emergency vehicle parameter.

Returning to FIG. 6, in this example embodiment, the location mode is registered (S610) after the vehicle is registered (S604). However, in some embodiments, the mode may be registered prior to the vehicle being registered. Further, in some embodiments, the mode may be registered concurrently with the vehicle being registered.

After the mode is registered (S610), in this example, a parameter is detected (S612) in order to register a signature for an emergency vehicle parameter. For example, returning to FIG. 5, let the parameter be sound as detected by parameter detecting component 522. This is a non-limiting example, wherein the detected parameter may be any known detectable parameter that is associated with an emergency vehicle, of which other non-limiting examples include electric fields, electro-magnetic fields, an image, a Blue Tooth signal, a Wi-Fi signal, light, vibrations, a change in electric fields, a change in magnetic fields, a change in electro-magnetic fields, a change in sound, a change in light, a change in vibrations, an actual signal from an emergency vehicle and combinations thereof.

Returning to FIG. 6, after the first parameter is detected (S612), it is determined whether another parameter is to be detected (S614). For example, returning to FIG. 5, controlling component 528 may instruct at least one of field-detecting component 512 and parameter-detecting component 522 to detect another parameter.

Sound may be a relatively distinct parameter that may be used to detect an emergency vehicle. However, there may be situations that elicit a false positive, such as the sound of an emergency vehicle on the radio. As such, in order to reduce the probability of a false positive detection of an emergency vehicle, a second detectable parameter associated with emergency may be used. Along this notion, it is an example aspect of the invention to detect a plurality of parameters associated with an emergency vehicle to increase the probability of a correct detection of the emergency vehicle.

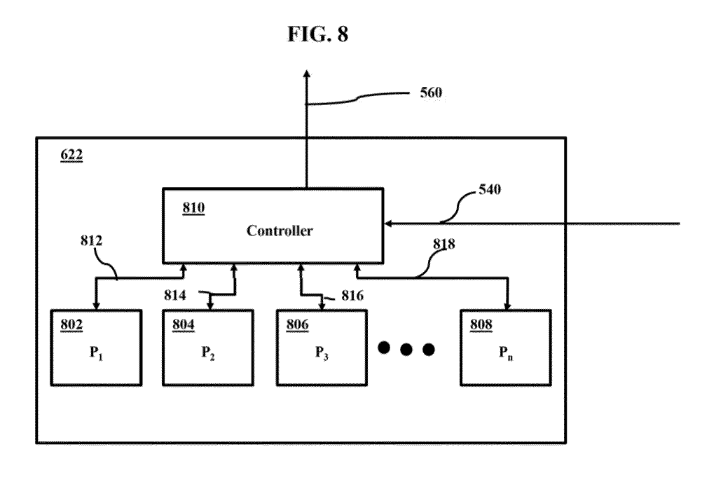

In some embodiments, device 502 has a predetermined number of parameters to detect, wherein controlling component 528 may control such detections. For example, the first parameter to be detected (in S612) may be sound, wherein controlling component 528 may instruct parameter-detecting component 522 to detect sound. Further, a second parameter to be detected may be another known detected parameter additionally associated with an emergency vehicle, e.g., an oscillating frequency of light (from the twirling lights on the emergency vehicle), wherein controlling component 528 may instruct parameter-detecting component 522 to detect the second parameter. Further, parameter-detecting component 522 may be able to detect many parameters. This will be described with greater detail with reference to FIG. 8.

FIG. 8 illustrates an example parameter-detecting component 522.

As shown in the figure, parameter-detecting component 522 includes a plurality of detecting components, a sample of which are indicated as a first detecting component 802, a second detecting component 804, a third detecting component 806 and an n-th detecting component 808. Parameter-detecting component 522 additionally includes a controlling component 810.

In this example, detecting component 802, detecting component 804, detecting component 806, detecting component 808 and controlling component 810 are illustrated as individual devices. However, in some embodiments, at least two of detecting component 802, detecting component 804, detecting component 806, detecting component 808 and controlling component 810 may be combined as a unitary device. Further, in some embodiments, at least one of detecting component 802, detecting component 804, detecting component 806, detecting component 808 and controlling component 810 may be implemented as a computer having tangible computer-readable media for carrying or having computer-executable instructions or data structures stored thereon.

Controlling component 810 is configured to communicate with: detecting component 802 via a communication line 812; detecting component 804 via a communication line 814; detecting component 806 via a communication line 816; and detecting component 808 via a communication line 818. Controlling component 810 is operable to control each of detecting component 802, detecting component 804, detecting component 806 and detecting component 808. Controlling component 810 is additionally configured to communicate with controlling component 528 of FIG. 5 via communication line 540 and to communicate with field-detecting component 512 of FIG. 5 via communication line 290.

The detecting components may each be a known detecting component that is able to detect a known parameter. For example each detecting component may be a known type of detector that is able to detect at least one of magnetic fields, electric fields, electro-magnetic fields, velocity, acceleration, angular velocity, angular acceleration, geodetic position, sound, temperature, an image, a Blue Tooth signal, a Wi-Fi signal, light, vibrations, pressure, biometrics, contents of surrounding atmosphere, a change in electric fields, a change in magnetic fields, a change in electro-magnetic fields, a change in velocity, a change in acceleration, a change in angular velocity, a change in angular acceleration, a change in geodetic position, a change in sound, a change in temperature, a change in light, a change in vibrations, a change in pressure, a change in biometrics, a change in contents of surrounding atmosphere and combinations thereof. For purposes of discussion, let: detecting component 802 be able to detect a sound associated with an emergency vehicle; detecting component 804 be able to detect light associated with an emergency vehicle; detecting component 806 be able to detect vibrations; and detecting component 808 be able to detect geodetic position.

In some non-limiting example embodiments, at least one of the detecting components of parameter-detecting component 522 may detect a respective parameter as an amplitude at an instant of time. In some non-limiting example embodiments, at least one of the detecting components of parameter-detecting component 522 may detect a respective parameter as a function over a period of time.

Each of the detecting components of parameter-detecting component 522 is able to generate a respective detected signal based on the detected parameter. Each of these detected signals may be provided to controlling component 810 via a respective communication line.

Controlling component 810 is able to be controlled by controlling component 528 via communication line 540.

Returning to FIG. 6, if another parameter is to be detected (Y at S614), then another parameter will be detected (612). For example, as shown in FIG. 5, controlling component 528 may then instruct parameter-detecting component 522 to detect another parameter via communication line 540. For purposes of discussion, let the second parameter to be detected be light. As such, at this point, as shown in FIG. 8, controlling component 810 instructs detecting component 802, via communication line 812, to detect light. Detecting component 802 provides a signal corresponding to the detected light to controlling component 810 via communication line 812.

This process will repeat until all the parameters to be detected are detected. In some embodiments, this process will repeat a predetermined number of times in order to detect predetermined types of parameters. In some embodiments, this process is only repeated until enough parameters are detected in order reach a predetermined probability threshold, which will reduce the probability of a false positive identification of an emergency vehicle.

Returning to FIG. 8, as just discussed, controlling component 810 is able to send individual detected signals from each detecting component. In other example embodiments, controlling component 810 is able to receive and hold the individual detected signals from each detecting component, wherein controlling component 810 is able to generate a composite detected signal that is based on the individual detected signals. The composite detected signal may be based on any of the individual detected signal, and combinations thereof. In some embodiments, controlling component 810 may additionally process any of the individual detected signals and combinations thereof to generate the composite detected signal. Non-limiting examples of further processes include averaging, adding, subtracting, and transforming any of the individual detected signals and combinations thereof.

It should be further noted that in some embodiments, all parameters that are to be detected are detected simultaneously. In such a case, for example, as shown in FIG. 5, controlling component 528 may then instruct parameter-detecting component 522 to detect all parameters via communication line 540. As such, at this point, as shown in FIG. 8, controlling component 810 instructs all the detecting components to detect their respective parameters. All the detecting components then provide a respective signal corresponding to the respective detected parameter to controlling component 810 via communication line 814. In this example, controlling component 810 may then provide the detected signal to field-detecting component 512 via communication line 290 as shown in FIG. 5.

Returning to FIG. 6, if no more parameters are to be detected (N at S614), then an emergency vehicle parameter signature is generated (S616). For example as shown in FIG. 5, parameter-detecting component 522 may generate an emergency vehicle parameter signature of the emergency vehicle parameter signal based on the detected parameter.

Non-limiting examples of the detecting of the parameters (S612 and S614), include the detecting warning of signal 112 from emergency vehicle 102 as shown in FIG. 1, the detecting of warning signal 208 as shown in FIG. 2 and the detecting of warning signal 304 as shown in FIG. 3 and combinations thereof. Still further, an example of the detecting of the parameters (S612 and S614) may include a simulation system for training device 502, wherein the simulation system emulates the detecting warning of signal 112 from emergency vehicle 102 as shown in FIG. 1, the detecting of warning signal 208 as shown in FIG. 2 and the detecting of warning signal 304 as shown in FIG. 3 and combinations thereof.

Returning to FIG. 6, once the emergency vehicle parameter signature is generated (S616), the emergency vehicle parameter signature is input into memory (S618). For example, as shown in FIG. 5, field-detecting component 512 provides the signature to input component 514 via communication line 546.

In an example embodiment, input component 514 includes a GUI that informs a user of device 502 that an emergency vehicle parameter signature has been generated. Input component 514 may additionally enable the user to input an association between the registered location, the registered mode and the generated emergency vehicle parameter signature. For example, input component 514 may display on a GUI a message such as “A signature was generated. To what emergency vehicle parameter is the signature associated?” Input component 514 may then display an input prompt for the user to input, via the GUI, an emergency vehicle parameter to be associated with the generated emergency vehicle parameter signature.

Input component 514 may then provide the emergency vehicle parameter signature, and the association to a specific location and mode, to database 504 via communication line 550.

As discussed above, in some embodiments, database 504 is part of device 502, whereas in other embodiments, database 504 is separate from device 502. Data input and retrieval from database 504 may be faster when database 504 part of device 502, as opposed to cases where database 504 is distinct from device 502. However, size may be a concern when designing device 502, particularly when device 502 is intended to be a handheld device such as a smartphone. As such, device 502 may be much smaller when database 504 is distinct from device 502, as opposed to cases where database 504 is part of device 502.

Consider an example embodiment, where database 504 is part of device 502. In such cases, input component 514 may enable a user to input emergency vehicle parameter signatures and the location/mode associations, for a predetermined number of emergency vehicle parameters. In this manner, database 504 will only be used for device 502.

Now consider an example embodiment, where database 504 is separate from device 502. Further, let database 504 be much larger than the case where database 504 is part of device 502. Still further, let database 504 be accessible to other devices in accordance with aspects of the present invention. In such cases, input component 514 may enable a user to input emergency vehicle parameter signatures and the location/mode associations, for a much larger predetermined number of emergency vehicle parameters. Further, in such cases, input component 514 may enable other users of similar devices to input emergency vehicle parameter signatures and the location/mode associations, for even more emergency vehicle parameters.

At this point, method 600 stops (S620).

A location, a mode of operation at the registered location, and an emergency vehicle parameter have been registered. In accordance with aspects of the present invention, device 502 will be able to subsequently automatically determine when it is in the registered mode at the registered location. When device 502 automatically determines such situations, device 502 will search for an emergency vehicle parameter.

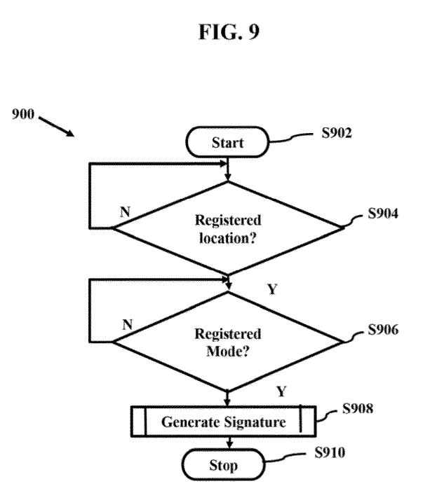

Returning to FIG. 4, now that a location, a location mode and an emergency vehicle parameter have been registered (S404), a future emergency vehicle parameter may be detected (S406). In other words, now that a location has been registered, and now that a mode of operation of device 502, within the location, has been registered, device 502 will detect whether it is in the registered location while operating in the location mode and a predetermined emergency vehicle parameter is detected. This will further described with additional reference to FIG. 9.

FIG. 9 illustrates a method 900 for detecting an emergency vehicle parameter when in a registered location while operating in a registered mode.

As shown in the figure, method 900 starts (S902) and it is determined whether the current location is a registered location (S904). The current location may be detected by any known system or method. In an example embodiment, the location is detected in a manner as disclosed in U.S. patent application Ser. No. 14/105,934.

For example, returning to FIG. 7, a plurality of parameters may be detected via field-detecting component 512 and parameter-detecting component 522. The detected parameters may be used to generate a location signature of the current location. The generated location signature is then compared with previously stored location signatures associated with previously registered locations, as stored in database 504. When the generated location signature coincides with a previously stored location signature associated with previously registered location, identifying portion 520 identifies the current location as one of the previously registered locations.

If device 502 is not in a registered location (N at S904), then method 900 continues until it is determined that device 502 is in a registered location (Y at S904).

Returning to FIG. 9, after determining that the current location is a registered location (Y at S904), it is determined whether the current mode of operation is a registered location mode corresponding to the registered location (S906). The current mode may be detected in a manner similar to that discussed above with reference to FIG. 6 (S608). In particular, for example, returning to FIG. 7, controlling component 528 may determine whether the current mode is registered.

If device 502 is not in a registered mode corresponding to the registered location (N at S906), then method 900 continues until it is determined that device 502 is in the corresponding registered mode (Y at S906).

After determining that the current mode is the corresponding registered mode (Y at S906), an emergency vehicle parameter is detected (S908). Consider, for example, the situation discussed above with reference to FIG. 1. In accordance with aspects of the present invention, device 106 may detect parameters associated with previously registered emergency vehicle parameter. These detected parameters may be used to generate new emergency vehicle parameter signatures.

By analyzing at least one detected parameter associated with device 106, it may be determined whether or not an emergency vehicle parameter is present.

When device 106 is in a registered location and is operating in a registered mode corresponding to the registered location and a specific emergency vehicle parameter is detected, device 106 may automatically perform a function, non-limiting examples of which include provide a warning to the user and transmitting an emergency vehicle signal.

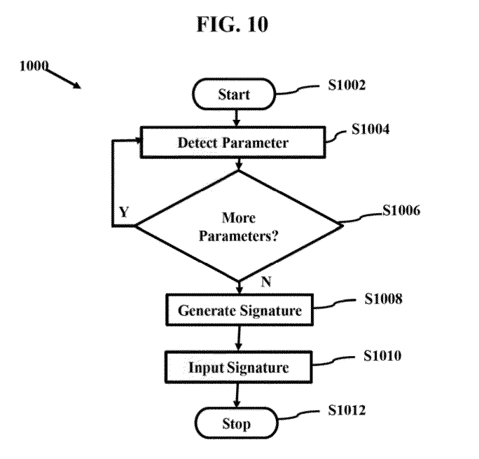

This aspect of the present invention will be further described with reference to FIG. 10.

FIG. 10 illustrates an example method 1000 of generating an emergency vehicle parameter signature in accordance with aspects of the present invention.

As shown in the figure, method 1000 starts (S1002) and a parameter is detected (S1004). A parameter may be detected by any known method or system. In an example embodiment, a parameter is detected in a manner similar to that discussed above with reference to method 600, e.g., S612. For example, with reference to the situation discussed above in FIG. 1, the parameter may be sound associated with emergency vehicle 102, wherein sound is part of warning signal 112. Other non-limiting examples of detected parameters include at least one of magnetic fields, electric fields, electro-magnetic fields, velocity, acceleration, angular velocity, angular acceleration, geodetic position, sound, temperature, an image, a Blue Tooth signal, a Wi-Fi signal, light, vibrations, pressure, biometrics, contents of surrounding atmosphere, a change in electric fields, a change in magnetic fields, a change in electro-magnetic fields, a change in velocity, a change in acceleration, a change in angular velocity, a change in angular acceleration, a change in geodetic position, a change in sound, a change in temperature, a change in light, a change in vibrations, a change in pressure, a change in biometrics, a change in contents of surrounding atmosphere and combinations thereof.

Returning to FIG. 10, after the parameter has been detected (S1004), it is determined whether more parameters are to be detected (S1006). The additional parameters may be detected by any known method or system. In an example embodiment, additional parameters may be detected in a manner similar to that discussed above with reference to method 600, e.g., S614. For example, with reference to the situation discussed above in FIG. 1, an parameter may be light associated with emergency vehicle 102, wherein light is another part of warning signal 112.

Returning to FIG. 10, if another parameter is to be detected (Y at S1006), then another parameter will be detected (S1004). This process will repeat until all the parameters to be detected are detected. In some embodiments, this process will repeat a predetermined number of times in order to detect predetermined types of parameters. In some embodiments, this process is only repeated until enough parameters are detected in order reach a predetermined probability threshold, which will reduce the probability of a false positive emergency vehicle parameter determination.

An emergency vehicle parameter signature is then generated (S1008). The emergency vehicle parameter signature may be generated by any known method or system. In an example embodiment, a signature is generated a manner similar to that discussed above with reference to method 900. e.g., S908.

Returning to FIG. 10, after the emergency vehicle parameter signature is generated (S1008), it is then inputted (S1010). As shown in FIG. 5, this second signature is provided to comparing component 518.

Method 1000 then stops (S1012). Returning to FIG. 9, method 900 additionally stops (S910).

In accordance with aspects of the present invention, method 900 may be performed continuously, or at predetermined intervals. In some embodiments, a predetermined time threshold, tₜₕ is stored, for example in controlling component 518. The time threshold, tₜₕ, may be used to decrease the likelihood of a false positive identification of an emergency vehicle parameter. This may be accomplished by performing method 900 at a first time, t₁, then subsequently performing method 900 a second time, t₂, wherein the difference between t₁ and t₂ is Δt. If performance of method 900 indicates an emergency vehicle parameter and if Δt>tₜₕ, then it is determined that there is indeed an emergency vehicle parameter. In short, if the emergency vehicle parameter is detected after a long enough period, it is likely to be an accurate detection of an emergency vehicle parameter.

Returning to FIG. 4, after the emergency vehicle parameter has been detected (S406), it is verified (S408). For example, a device in accordance with aspects of the present invention would determine whether the newly detected emergency vehicle parameter is the emergency vehicle parameter that was previously registered. A more detailed discussion of registration will now be provided with additional reference to FIG. 11.

FIG. 11 illustrates an example method 1100 of verifying an emergency vehicle parameter in accordance with aspects of the present invention.

Method 1100 starts (S1102) and the previously stored emergency vehicle parameter signature is accessed (S1104). For example, as shown in FIG. 5, access component 516 retrieves the previously-stored emergency vehicle parameter signature from database 504 via communication line 554. Access component 516 then provides the retrieved, previously-stored emergency vehicle parameter signature to comparator 518 via communication line 556.

Returning to FIG. 1, now that the previously stored emergency vehicle parameter signature has been accessed (S1104), the emergency vehicle parameter signatures are compared (S1106). For example, as shown in FIG. 5, comparator 518 compares the retrieved, previously stored emergency vehicle parameter signature as provided by access component 516 with the newly generated emergency vehicle parameter signature as provided by field-detecting component 512.

Returning to FIG. 11, now that the emergency vehicle parameter signatures have been compared (S1106), it is determined whether an emergency vehicle is detected (S1108). For example, as shown in FIG. 5, comparator 518 provides an output to identifying component 520 via communication line 558. If the retrieved, previously stored emergency vehicle parameter signature as provided by access component 516 matches the newly generated emergency vehicle parameter signature as provided by field-detecting component 512, then the newly detected emergency vehicle parameter is the same emergency vehicle parameter that was previously registered. In such a case, identifying component 520 may indicate that the newly detected emergency vehicle parameter is the same emergency vehicle parameter that was previously registered. If the retrieved, previously stored emergency vehicle parameter signature as provided by access component 516 does not match the newly generated emergency vehicle parameter signature as provided by field-detecting component 512, then the newly detected emergency vehicle parameter is not the same emergency vehicle parameter that was previously registered. In such a case, identifying component 520 may indicate that the newly detected emergency vehicle parameter is not the same emergency vehicle parameter that was previously registered.

If a determination is made that an emergency vehicle is not detected (N at S1108), then method 1100 stops (S1112).

If a determination is made that an emergency vehicle is detected (Y at S1108), then a function is performed (S1110). For example, returning to FIG. 2, consider the situation where device 106 detects emergency vehicle 102 (Y at S1108). In such a situation, device 106 may generate an emergency vicinity signal. For example, as shown in FIG. 5, identifying component 520 may generate an emergency vicinity signal identifying a recognized emergency vehicle. The emergency vicinity signal is provided to controlling component 528. The emergency vicinity signal enable controlling component 528 to perform additional functions such as warning the driver of vehicle 104 that emergency vehicle 102 is nearby, wherein the warning may be an audible warning, a visual warning, a vibration or combination thereof. In another embodiment, device 106 may transmit emergency vehicle signal 208 to device 204. In some embodiments, the transmission of emergency vehicle signal 208 may be a broadcast to an area, wherein vehicle 202 is within the broadcast area. In other embodiments, the transmission of emergency vehicle signal 208 may be a network communication, for example over a cellular network.

Returning to FIG. 11, now that a function has been performed (S1110), method 1100 stops (S1112).

Returning to FIG. 4, after the emergency vehicle parameter has been verified, the data is updated (S410). For example, in some embodiments, as shown in FIG. 5, comparator 518 may determine that the previously stored emergency vehicle parameter signature as provided by access component 516 does not exactly match the newly generated emergency vehicle parameter signature as provided by field-detecting component 512, but the difference between the previously stored emergency vehicle parameter signature as provided by access component 516 does not exactly match the newly generated emergency vehicle parameter signature as provided by field-detecting component 512 is within a predetermined acceptable limit. In such cases, identifying component 520 may indicate that the newly detected emergency vehicle parameter is still the same emergency vehicle parameter that was previously registered. Further, comparator 518 may provide the newly generated emergency vehicle parameter signature as provided by field-detecting component 512 to access component 516 via communication line 556. Access component 516 may then provide the newly generated emergency vehicle parameter signature to database 504 via communication line 554.

In this manner, database 504 may be “taught” to accept variations of previously registered emergency vehicle parameter signatures. In some embodiments, an average of recognized emergency vehicle parameter signatures may be stored for future use. In some embodiments, a plurality of each recognized emergency vehicle parameter signature may be stored for future use.

Returning to FIG. 4, after updating (S410) device 502 waits to detect a new emergency vehicle parameter (S406) and method 400 continues.

The example embodiments discussed above are drawn to identifying, via a communication device, a location using fields and other parameters associated therewith. Once in an identified location, and in a location mode, the communication device may automatically detect an emergency vehicle parameter.

In accordance with aspects of the present invention, a wireless communication device is able to automatically detect the presence of an emergency vehicle. Once detected the wireless communication device is additionally able to warn the user of the emergency vehicle and or transmit a notification of the emergency vehicle to other communication devices.

In the drawings and specification, there have been disclosed embodiments of the invention and, although specific terms are employed, they are used in a generic and descriptive sense only and not for purposes of limitation, the scope of the invention being set forth in the following claims.

What is claimed as new and desired to be protected by Letters Patent of the United States is:

1. A device for use at a location, said device comprising:
a processing component operable to operate in a location mode when at the location and to operate in a second mode;
a location mode determining component operable to determine whether said processing component is operating in the location mode and to generate a location mode signal when said processing component is operating in the location mode; and
a detecting component operable to detect an emergency vehicle parameter associated with an emergency vehicle and to generate an emergency vicinity signal based on the location mode signal and the detected emergency vehicle parameter.

2. The device of claim 1, wherein said processing component is further operable to perform a function while in the location mode and based on the emergency vicinity signal.

3. The device of claim 1, further comprising a transmitting component operable to transmit an emergency vehicle signal based on the emergency vicinity signal.

4. The device of claim 3, wherein said detecting component is operable to detect the emergency vehicle parameter as one of the group consisting of a second emergency vehicle signal, light, sound, a change in light, a change in sound and combinations thereof.

5. The device of claim 4,
wherein said detecting component is operable to detect the emergency vehicle parameter as the second emergency vehicle signal, and
wherein said detecting component comprises a receiving component operable to receive the second emergency vehicle signal from a communication device.

6. The device of claim 4, wherein said detecting component is operable to detect the emergency vehicle parameter as the second emergency vehicle signal, and
wherein said detecting component comprises a receiving component operable to receive the second emergency vehicle signal from the emergency vehicle.

7. A method for use at a location, said method comprising:
operating a processing component, that is operable to operate in a location mode when at the location and in a second mode, in the location mode;
determining, via a location mode determining component, whether the processing component is operating in the location mode;
generating, via the location mode determining component, a location mode signal when the processing component is operating in the location mode;
detecting, via a detecting component, an emergency vehicle parameter associated with an emergency vehicle; and
generating, via the detecting component, an emergency vicinity signal based on the location mode signal and the detected emergency vehicle parameter.

8. The method of claim 7, further comprising performing, via the processing component, a function while in the location mode and based on the emergency vicinity signal.

9. The method of claim 7, further comprising transmitting, via a transmitting component, an emergency vehicle signal based on the emergency vicinity signal.

10. The method of claim 9, wherein said detecting an emergency vehicle parameter comprises detecting, as the emergency vehicle parameter one of the group consisting of a second emergency vehicle signal, light, sound a change in light, a change in sound and combinations thereof.

11. The method of claim 10,
wherein said detecting, via a detecting component, an emergency vehicle parameter associated with an emergency vehicle comprises detecting the emergency vehicle parameter as the second emergency vehicle signal, and
wherein said detecting, via a detecting component, an emergency vehicle parameter associated with an emergency vehicle further comprises detecting via a detecting component comprises that comprises a receiving component operable to receive the second emergency vehicle signal from a communication device.

12. The method of claim 10,
wherein said detecting, via a detecting component, an emergency vehicle parameter associated with an emergency vehicle comprises detecting the emergency vehicle parameter as the second emergency vehicle signal, and
wherein said detecting, via a detecting component, an emergency vehicle parameter associated with an emergency vehicle further comprises detecting via a detecting component comprises that comprises a receiving component operable to receive the second emergency vehicle signal from the emergency vehicle.

13. A non-transitory, tangible, computer-readable media having computer-readable instructions stored thereon, for use at a location, the computer-readable instructions being capable of being read by a computer and being capable of instructing the computer to perform the method comprising:
operating a processing component, that is operable to operate in a location mode when at the location and in a second mode, in the location mode;
determining, via a location mode determining component, whether the processing component is operating in the location mode;
generating, via the location mode determining component, a location mode signal when the processing component is operating in the location mode;
detecting, via a detecting component, an emergency vehicle parameter associated with an emergency vehicle; and
generating, via the detecting component, an emergency vicinity signal based on the vehicle mode signal and the detected emergency vehicle parameter.

14. The non-transitory, tangible, computer-readable media of claim 13, wherein the computer-readable instructions are capable of instructing the computer to perform the method further comprising performing, via the processing component, a function while in the location mode and based on the emergency vicinity signal.

15. The non-transitory, tangible, computer-readable media of claim 13, wherein the computer-readable instructions are capable of instructing the computer to perform the method further comprising transmitting, via a transmitting component, an emergency vehicle signal based on the emergency vicinity signal.

16. The non-transitory, tangible, computer-readable media of claim 15, wherein the computer-readable instructions are capable of instructing the computer to perform the method such said detecting an emergency vehicle parameter comprises detecting, as the emergency vehicle parameter one of the group consisting of a second emergency vehicle signal, light, sound a change in light, a change in sound and combinations thereof.

17. The non-transitory, tangible, computer-readable media of claim 16, wherein the computer-readable instructions are capable of instructing the computer to perform the method
such that said detecting, via a detecting component, an emergency vehicle parameter associated with an emergency vehicle comprises detecting the emergency vehicle parameter as the second emergency vehicle signal, and
such that said detecting, via a detecting component, an emergency vehicle parameter associated with an emergency vehicle further comprises detecting via a detecting component comprises that comprises a receiving component operable to receive the second emergency vehicle signal from a communication device.

18. The non-transitory, tangible, computer-readable media of claim 16, wherein the computer-readable instructions are capable of instructing the computer to perform the method
such that said detecting, via a detecting component, an emergency vehicle parameter associated with an emergency vehicle comprises detecting the emergency vehicle parameter as the second emergency vehicle signal, and
such that said detecting, via a detecting component, an emergency vehicle parameter associated with an emergency vehicle further comprises detecting via a detecting component comprises that comprises a receiving component operable to receive the second emergency vehicle signal from the emergency vehicle.
